(19) United States
(12) Patent Application Publication
(10) Pub. No.: US 2007/0174626 A1
(43) Pub. Date: Jul. 26, 2007

(54) Method and apparatus for generating and validating digital signature

(75) Inventors: Mi-suk Huh, Suwon-si (KR); Kyung-hee Lee, Yongin-si (KR); Tae-chul Jung, Seongnam-si (KR); Alexandra Afanasyeva, St. Petersburg (RU); Sergey Bezzateev, St. Petersburg (RU); Evgeny Krouk, St. Petersburg (KR); Alexey Sitalov, St. Petersburg (RU); Mikhail Stepanov, St. Petersburg (RU)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/366,417

(22) Filed: Mar. 3, 2006

(30) Foreign Application Priority Data
Mar. 5, 2005 (KR) 2005-0018392

(51) Int. Cl. H04L 9/00

(52) U.S. Cl. 713/180

(57) ABSTRACT

Provided are a method and an apparatus for generating and validating a digital signature. The apparatus for generating the digital signature includes: a converter converting a message to be transmitted into a codeword having a set length using a Griesmer code; and a digital signature generator allowing each of bits constituting the codeword to correspond to one of a plurality of secret keys constituting a table and combining the corresponding secret keys to generate the digital signature. The apparatus for validating the digital signature includes: a converter converting a received message into a codeword having a set length using a Griesmer code; and a digital signature validator allowing each of bits constituting the codeword to correspond to one of a plurality of public keys constituting a table and validating whether a value obtained by combining the corresponding public keys is equal to a value obtained by hashing the digital signature.

### CROSS-REFERENCE TO RELATED APPLICATIONS

This application claims priority from Korean Patent Application No. 2005-0018392 filed on Mar. 5, 2005 in the Korean Intellectual Property Office, the disclosure of which is incorporated herein by reference.

### BACKGROUND OF THE INVENTION

1. Field of the Invention

The present invention relates to an electronic signature, and more particularly, to a method of generating a digital signature that is a kind of an electronic signature so as to quickly perform a complicated signature.

2. Description of the Related Art

Digital signatures mean information generated via computers or the like, not with pens or writing materials, to validate identities of signers. The digital signatures are electronic data attached to or logically coupled to data messages and used to validate the identities of signers, and approvals of the signers, with respect to the contents of the data messages. The digital signatures may be electronic substitutions for manual signatures or seals, i.e., information generated via computers instead manual writing implements. In general, the digital signatures use a public key encryption method (an asymmetric cryptography)

Such a digital signature validates that a writer of the digital signature writes the digital signature and the digital signature has not been counterfeited or falsified during its transmission and/or reception and prevents the signer from denying the veracity of the digital signature. Digital signatures can contribute to reducing the loss of important information that may occur during internet shopping, financial transactions, or the like. Thus, if digital signatures are used, the embezzlement or falsification of personal information can be prevented.

The digital signatures may be used for financial transactions such as Internet banking or the like, Internet public services, Internet shopping, and the like. The application of the digital signatures may be extended to international electronic commercial transactions, electronic votes, and the like. Authenticated certificates necessary for Internet banking or on-line stock transactions represent digital signatures that are issued by nation designated certification authorities and have public keys managed by the nation designated certification authorities.

FIG. 1 illustrates a table including secret keys (SKs) used for generating digital signatures and a table including public keys (PKs). As shown in FIG. 1, an SK represented as a table includes q×n keys. A PK is obtained by hashing the SK. Since a hash function is a unidirectional function, the PK can be obtained from the SK. However, the SK cannot be obtained from the PK. Thus, a third person knowing only about the PK cannot obtain the SK.

FIG. 2 illustrates a table including codewords and SKs obtained by processing messages to be transmitted using a set method. As described above, digital signatures are generated using a table including SKs. In other words, the digital signatures are generated using combinations of the SKs corresponding to field's elements constituting the codewords. However, SKs, having been used to generate digital signatures, are exposed to attacks of third persons, and thus, must be limitedly re-used. Thus, a method of efficiently using SKs constituting a table is suggested to transmit many codewords or generate digital signatures using limitedly used SKs.

FIG. 2 illustrates four codewords formed of A0 through A3 and an example of generating digital signatures respectively corresponding to the four codewords. As shown in FIG. 2, the digital signature of A0 does not belong to a set of the digital signatures of A1 and A2 but belongs to a set of the digital signatures of A1, A2, and A3. Thus, if a SK table exists, two messages are stably signed. However, if three messages are signed, a new signature is highly likely to be counterfeited. In other words, in this case, two signatures do not expose all of SKs for signing a new message. However, if three signatures exist, a signature value of a new message can be induced from three signature values. A table including SKs and a signature system has two safe signatures. Therefore, a method of safely generating more many signatures using a SK table is required.

### SUMMARY OF THE INVENTION

Accordingly, one aspect of the present invention has been made to solve the above-mentioned problems, and provides a method of increasing a number of generable digital signatures by efficiently using secret keys (SK)s constituting a table.

Another aspect of the present invention is to provide a method of generating digital signatures safe from an attack of a third person by efficiently using SKs constituting a table.

According to another aspect of the present invention, there is provided a method of generating a digital signature, including: converting a message to be transmitted into a codeword having a set length using a Griesmer code; generating a secret key table having a size corresponding to parameters of the Griesmer code; allowing each of the bits constituting the codeword to correspond to one of a plurality of secret keys constituting the secret key table; and combining the corresponding secret keys to generate the digital signature.

According to another aspect of the present invention, there is provided a method of validating a digital signature, including: converting a received message into a codeword having a set length using a Griesmer code; allowing each of field's elements constituting the codeword to correspond to one of a plurality of public keys constituting a table; and validating whether a value obtained by combining the corresponding public keys is equal to a value obtained by hashing the digital signature piece by piece.

According to still another aspect of the present invention, there is provided an apparatus for generating a digital signature, including: a converter converting a message to be transmitted into a codeword having a set length using a Griesmer code; and a digital signature generator allowing each of field's elements constituting the codeword to correspond to one of a plurality of secret keys constituting a table and combining the corresponding secret keys to generate the digital signature.

According to yet another aspect of the present invention, there is provided an apparatus for validating a digital signature, including: a converter converting a received message into a codeword having a set length using a Griesmer code; and a digital signature validator allowing each of field's elements constituting the codeword to correspond to one of a plurality of public keys constituting a table and validating whether a value obtained by combining the corresponding public keys is equal to a value obtained by hashing the digital signature.

According to yet another aspect of the present invention, there is provided a system for validating a digital signature, including the apparatus for generating the digital signature and the apparatus for validating the digital signature.

Another aspect of the present invention suggests at least a method of using a Griesmer code to generate a digital signature.

### BRIEF DESCRIPTION OF THE DRAWINGS

The above aspects and features of the present invention will be more apparent by describing exemplary embodiments of the present invention with reference to the accompanying drawings, in which:

FIG. 1 is a view illustrating a corresponding relationship between an SK for generating a digital signature and a PK for checking whether the digital signature has been counterfeited;

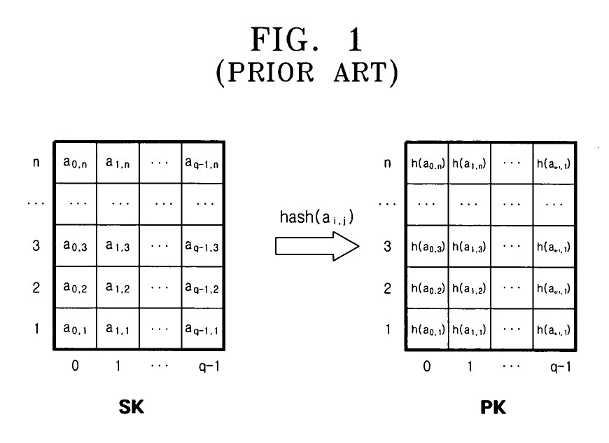

FIG. 2 is a view illustrating an example of generating a digital signature using transformed codewords and a table including a plurality of SKs;

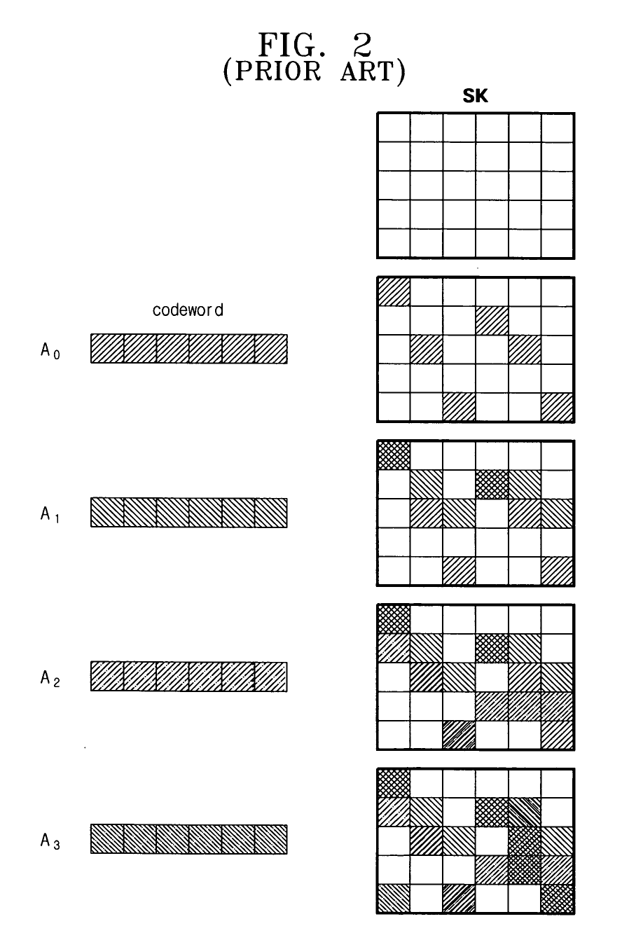

FIG. 3 is a view illustrating an operation of an apparatus for generating a digital signature according to an exemplary embodiment of the present invention;

FIG. 4 is a view illustrating an operation of an apparatus for validating a digital signature according to an exemplary embodiment of the present invention;

FIG. 5A is a view illustrating the number of digital signatures generated using a conventional method; and

FIG. 5B is a view illustrating the number of generated digital signatures according to an exemplary embodiment of the present invention.

### DETAILED DESCRIPTION OF EXEMPLARY EMBODIMENTS

Exemplary embodiments of the present invention will be described in greater detail with reference to the accompanying drawings.

In the following description, same drawing reference numerals are used for the same elements even in different drawings. The matters defined in the description such as a detailed construction and elements are provided to assist in a comprehensive understanding of the invention, and not to limit the scope of protection provided in the claims. Thus, it is apparent that the present invention can be carried out without those defined matters. Also, well-known functions or constructions are not described in detail since they would obscure the invention in unnecessary detail.

Hereinafter, a method of generating a digital signature using a Griesmer code will be described with reference to the attached drawings.

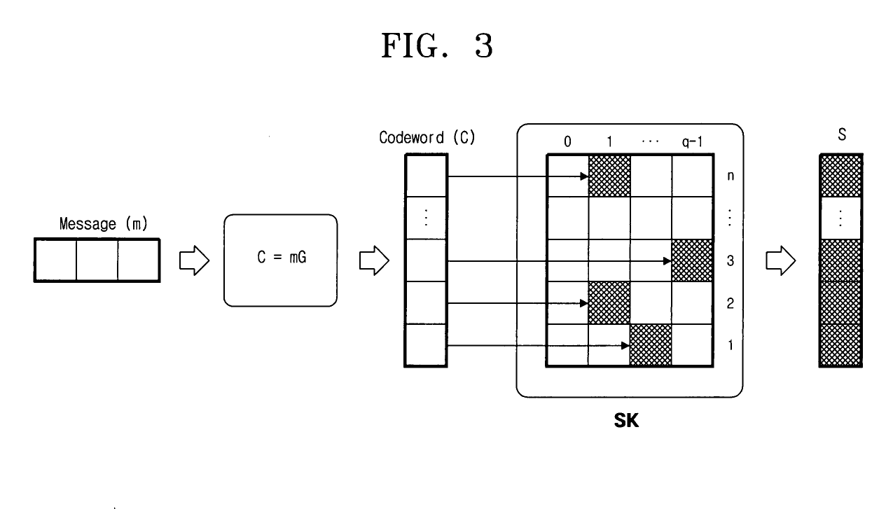

FIG. 3 is a view illustrating a process of generating a digital signature using a Griesmer code according to an embodiment of the present invention. Hereinafter, a part generating a digital signature is referred to as a digital signature generating apparatus including a converter and a digital signature generator. A part receiving the digital signature from the digital signature generating apparatus is referred to as a digital signature validating apparatus including a converter and a digital signature validator.

As described above, a method of generating a digital signature using a table including SKs may be one of two methods. In other words, there is a method of generating only one digital signature using one table. This digital signature is also called a one-time signature. There is another method of generating at least two digital signatures using one table. This digital signature is also referred to as a multi-time signature. For the one-time signature, whenever a digital signature is generated, an updated table must be transmitted and/or received between the digital signature generating apparatus and the digital signature validating apparatus. The multi-time signature is used to overcome this problem.

For the multi-time signature, at least two digital signatures can be generated using one table. Efficiency of the multi-time signature is improved with an increase in the number of generable digital signatures from each table. Thus, an aspect of the present invention suggests a method of increasing the number of generable digital signatures using a table.

The converter of the digital signature generating apparatus converts a received message m into a codeword C of a Griesmer code G. The detailed description of Griesmer code G will be omitted.

The digital signature generator extracts SKs corresponding to the codeword C from a table SK to generate a digital signature. Referring to FIG. 3, when the Griesmer code has parameters n, k, d, and q, the table SK includes q×n SKs, where n denotes a length of the codeword C. In other words, the length of the codeword C for the digital signature is n. This will be described in detail with reference to FIG. 3.

In other words, when the codeword is “a1, a2, . . . , and an” (0≦ai (q), SKs corresponding to the codeword C are values positioned at “(a1, 1), (a2, 2), . . . , and (an, n)” of the table SK.

The digital signature generator generates the digital signature through combinations of the SKs. The digital signature generator transmits the generated digital signature and the message m. As described above, an aspect of the present invention suggests a method of generating a digital signature using a Griesmer code.

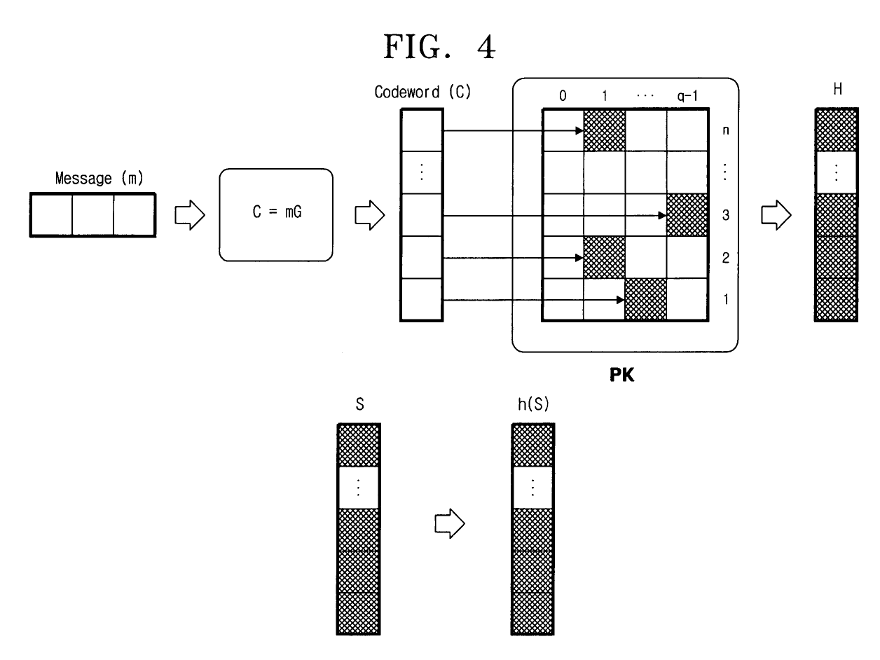

FIG. 4 is a view illustrating a process of validating whether a digital signature received by a digital signature validating apparatus has been counterfeited according to an embodiment of the present invention.

The converter converts a received message m into a codeword C of a Griesmer code G. As described above, the digital signature generating apparatus and the digital signature validating apparatus use the same code G. In other words, the converters of the digital signature generating apparatus and the digital signature validating apparatus respectively convert the received messages m into the codewords C of the Griesmer code G.

The digital signature validator extracts PKs corresponding to the codeword C from a table PK to compute a specific value H. Hereinafter, the specific value H is referred to as a hash value. As described above, the PKs are obtained by hashing SKs. Also, positions of a PK and an SK corresponding to field's elements constituting a codeword C are the same. In other words, a position of a PK value is detected from a codeword C generated with reference to a message m when a position of an SK to be signed is detected from an SK table so as to validate whether the PK value coincides with a result of hashing a signed value.

The digital signature validator hashes a received digital signature. The digital signature validator determines whether the hashed digital signature is equal to the hash value H. If the hashed digital signature pieces are equal to the hash value H, the digital signature validator determines that the received digital signature has not been counterfeited or falsified. If the hashed digital signature pieces are equal to the hash value H, the digital signature validator determines that the received digital signature has been counterfeited or falsified.

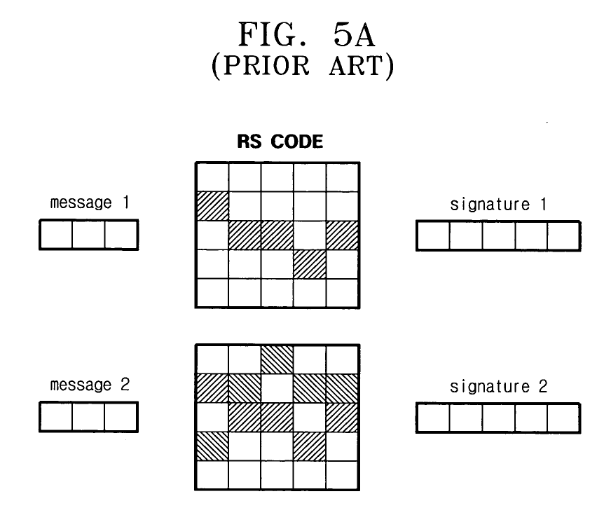

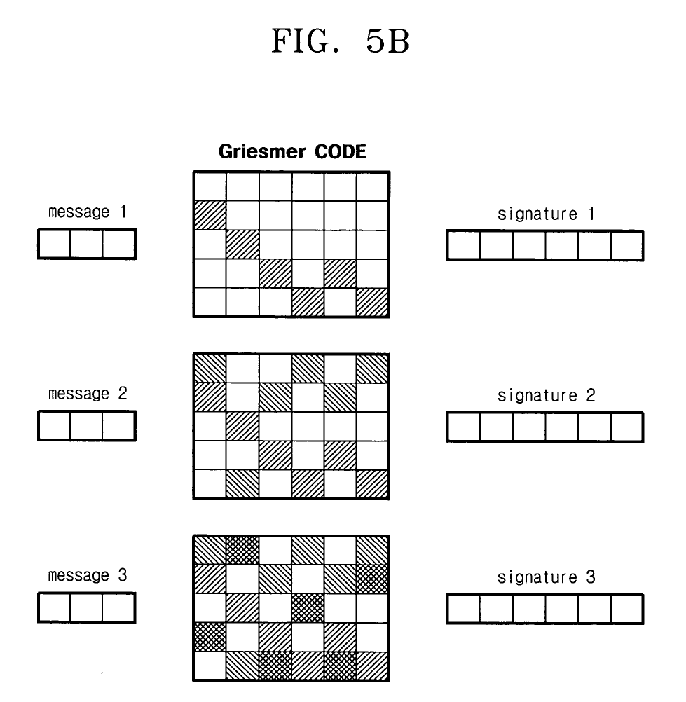

FIG. 5A is a view illustrating a case of generating a digital signature using a conventional RS code, and FIG. 5B is a view illustrating a case of generating a digital signature using a Griesmer code according to the present invention.

As shown in FIG. 5A, in a case where the RS code is used, two digital signatures are generated using 5×5 tables. However, in a case where the Griesmer code suggested in the present invention is used, three digital signatures are generated using 5×6 tables. Thus, the number of digital signatures generable using the Griesmer code can be increased.

As described above, according to the present invention, a digital signature generator can use a Griesmer code instead of an RS code to generate a digital signature. As a result, the number of digital signatures that may be generated by the digital signature generator using the Griesmer code can be increased.

The foregoing embodiments and advantages are. merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method of generating a digital signature, comprising:
converting a message to be transmitted into a codeword having a set length using a Griesmer code;
generating a secret key table having a size corresponding to parameters of the Griesmer code;
allowing each bit of bits constituting the codeword to correspond to one of a plurality of secret keys constituting the secret key table; and
combining the corresponding plurality of secret keys to generate the digital signature.

2. The method of claim 1, further comprising obtaining a plurality of public keys from the plurality of secret keys using a unidirectional function.

3. The method of claim 2, wherein the unidirectional function is a hash function.

4. The method of claim 1, further comprising transmitting the generated digital signature and the message.

5. A method of validating a digital signature, comprising:
converting a received message into a codeword having a set length using a Griesmer code;
setting each bit of field's elements constituting the codeword to correspond to one of a plurality of public keys constituting a table; and
determining whether a value obtained by combining the corresponding plurality of public keys is equal to a value obtained by hashing the digital signature.

6. The method of claim 5, wherein the plurality of public keys are obtained by hashing secret keys.

7. The method of claim 5, further comprising determining the signature is not counterfeited if the value obtained by the hashing the digital signature is equal to the value obtained by combining the plurality of public keys.

8. An apparatus for generating a digital signature, comprising:
a converter that converts a message to be transmitted into a codeword having a set length using a Griesmer code; and
a digital signature generator that sets each of field's elements constituting the codeword to correspond to one of a plurality of secret keys constituting a table and that combines the corresponding secret keys to generate the digital signature.

9. The apparatus of claim 8, wherein public keys are obtained from the plurality of secret keys using a unidirectional function.

10. The apparatus of claim 9, wherein the unidirectional function is a hash function.

11. The apparatus of claim 8, wherein the digital signature generator transmits the generated digital signature and the message.

12. An apparatus for validating a digital signature, comprising:
a converter that converts a received message into a codeword having a set length using a Griesmer code; and
a digital signature validator that sets each bit of field's elements constituting the codeword to correspond to one of a plurality of public keys constituting a table and validating whether a value obtained by combining the corresponding plurality of public keys is equal to a value obtained by hashing the digital signature.

13. The apparatus of claim 12, wherein the plurality of public keys are obtained by hashing secret keys.

14. The apparatus of claim 12, wherein if the value obtained by the hashing the digital signature is equal to the value obtained by combining the plurality of public keys, the digital signature validator determines that the digital signature is not counterfeited.

15. A system for validating a digital signature, comprising:
a first converter that converts a message to be transmitted into a codeword having a set length using a Griesmer code; and
a digital signature generator that sets each of bits constituting the codeword to correspond to one of a plurality of secret keys constituting a table and that combines the corresponding secret keys to generate the digital signature;
a second converter that converts a transmitted message into the codeword having the set length using the Griesmer code; and
a digital signature validator that sets each bit of the bits constituting the codeword to correspond to one of a plurality of public keys constituting a table and validating whether a value obtained by combining the corresponding plurality of public keys is equal to a value obtained by hashing the digital signature.
